(19) United States
(12) Patent Application Publication
(10) Pub. No.: US 2003/0118207 A1
(43) Pub. Date: Jun. 26, 2003

(54) Loudspeaker apparatus

(75) Inventor: Yoshimi Kudo, Yamagata-ken (JP)

Correspondence Address: ARENT FOX KINTNER PLOTKIN & KAHN, PLLC, Suite 600, 1050 Connecticut Avenue, N.W., Washington, DC, 20036-5339, US

(73) Assignee: PIONEER CORPORATION AND TOHOKU PIONEER CORPORATION

(21) Appl. No.: 10/321,379

(22) Filed: Dec. 18, 2002

(30) Foreign Application Priority Data
Dec. 25, 2001 (JP) 2001-391227

(51) Int. Cl. H04R 1/00; H04R 9/06; H04R 11/02

(52) U.S. Cl. 381/397; 381/407

(57) ABSTRACT

A plurality of heat conduction bodies comprising a metallic material are located with a space held between each other, and attached with a connection with at least one of a voice coil bobbin comprising an insulating material and a voice coil. Further, one end of each heat conduction body is connected to a center cap comprising a metallic material. When the voice coil generates heat, the heat can be radiated by transmitting it to the center cap through the heat conduction body. Additionally, the heat conduction body with a shape of band is attached with a space held between each other, and the voice coil bobbin is formed with an insulating material, so that an eddy current caused by a magnetic field in a magnetic gap can be restrained from occurring.

### BACKGROUND OF THE INVENTION

1. Field of the Invention

The present invention relates to a loudspeaker apparatus for reproducing sound through transmitting, for example, a piston vibration of a voice coil bobbin inserted into a magnetic gap to a diaphragm.

The present application claims priority from Japanese Patent Application No. 2001-391227, the disclosure of which is incorporated herein by reference for all purposes.

2. Description of the Related Prior Art

Conventionally, there has been known an electrodynamic type loudspeaker apparatus, in which particularly a moving coil type loudspeaker apparatus has been generally used.

The moving coil type loudspeaker apparatus has a voice coil bobbin with a voice coil wound therewith which is inserted into a magnetic gap, and a diaphragm with a cone shape is connected to the voice coil bobbin.

When supplying current as a sound signal to the voice coil, a driving force F(=B×L×i) is generated in the voice coil in accordance with a Fleming's rule, where B is a magnetic flux density of the magnetic gap, L is all length of the voice coil, and i is a current which flows into the voice coil. According to an amplitude variation of the sound signal, the driving force F of the voice coil is changed, thereby causing a piston vibration of the voice coil bobbin. The vibration is transmitted to the diaphragm so that the sound is reproduced.

In the conventional moving coil type loudspeaker apparatus, heat is generated when supplying the current into the voice coil. Therefore, it is important to improve a heat radiation effect at the voice coil and the voice coil bobbin so as not to accumulate the heat. As an example of the improvement, a voice coil bobbin made of metal has been employed.

However, there occurs an eddy current within the voice coil bobbin made of metal when the bobbin takes the piston vibration in the magnetic gap as mentioned above, and also when the bobbin goes across a magnetic flux in the magnetic gap. Under the influence of the eddy current, a magnetic damping occurs. As a result, a quality factor or an impedance is forced to change, so that a tone quality of sound reproduced by the diaphragm may be deteriorated.

### SUMMARY OF THE INVENTION

The present invention is made for solving the above-mentioned problems. An object of the present invention is to provide a loudspeaker apparatus for restraining an eddy current from occurring, and also for enabling a heat radiation effect to be improved.

According to the first aspect of the present invention, there is provided a loudspeaker apparatus having a diaphragm, a bobbin connected to the diaphragm and provided with a coil, and a magnetic gap for assigning the coil a magnetic field, comprising a center cap provided on a top of the bobbin, and a plurality of heat conduction bodies contacted with at least one of the bobbin and the coil, and connected to the center cap, wherein the bobbin is formed with an insulating material, the center cap is formed with a metallic material superior in heat conductive characteristic, and the plurality of heat conduction bodies are formed with a metallic material superior in heat conductive characteristic having a shape of wide band, which are provided with a space held between each other, respectively.

According to the second aspect of the present invention, one end of the heat conduction body is connected to the center cap, and the other end is put between the bobbin and the coil.

According to the third aspect of the present invention, one end of the heat conduction body is connected to the center cap, and the other end is contacted with the coil wound around the bobbin.

According to the fourth aspect of the present invention, the metallic material forming the heat conduction body is a copper foil.

According to such a construction of the loudspeaker apparatus, when a current is supplied to the coil and heat is generated at the coil, the heat conduction bodies transmit the heat to the center cap. Since the center cap is formed with the metallic material which is superior in the heat conductive characteristic, the heat transmitted by the heat conduction bodies can be radiated. Thus, the heat generated at the coil can be prevented from being accumulated at the bobbin and the coil.

In addition, since the bobbin is formed with the insulating material, an eddy current usually caused by the magnetic field in the magnetic gap does not occur at the bobbin itself. Further, since the plurality of heat conduction bodies are formed with a shape of band, respectively, and with a space held between each other, the eddy current generated at each heat conduction body can be restrained so much despite the metallic material.

Therefore, the loudspeaker apparatus of the present invention has such a construction that the heat generated by the coil can be efficiently radiated, and an occurrence of the eddy current can be reduced largely.

In particular, since the heat conduction body is formed with the copper foil, the heat generated by the coil can be more efficiently transmitted to the center cap, so that the heat radiation effect can be further improved.

### BRIEF DESCRIPTION OF THE DRAWINGS

These and other objects and advantages of the present invention will become clearly understood from the following description with reference to the accompanying drawings, wherein:

FIG. 1 is a longitudinal sectional schematic view showing a construction of a loudspeaker apparatus of the present embodiment;

FIG. 2 is a side elevation view showing a construction of a voice coil, a voice coil bobbin, a center cap, and a heat conduction body of FIG. 1, a part of which is sectioned;

FIG. 3 is a view showing the other example of the present embodiment which corresponds with FIG. 2; and

FIGS. 4a-4c are views showing various shapes of the heat conduction body.

### DETAILED DESCRIPTION OF THE PREFERRED EMBODIMENTS

The preferred embodiments of the present invention will be described with reference to the attached drawings, using an example of a moving coil type loudspeaker apparatus.

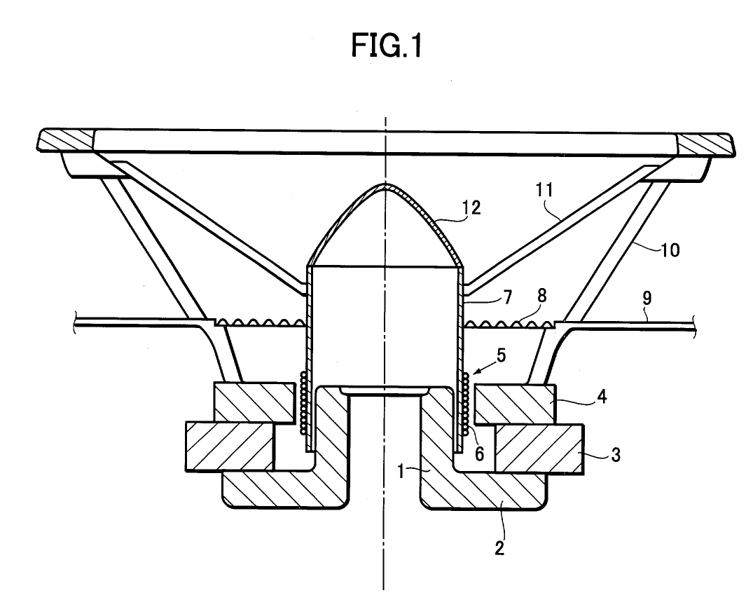

FIG. 1 is a longitudinal sectional view showing a construction of a loudspeaker apparatus of the present embodiment, which is sectioned along a central axis line (virtual line) of a voice coil bobbin.

In FIG. 1, a pole piece 1 with a substantially cylindrical shape is integrally formed with a back plate 2. On a flange portion comprising the back plate 2, a ring-shaped magnet 3 and a top plate 4 are piled up and bonded together, respectively. A magnetic gap 5 for generating a magnetic field is formed in a gap where the pole piece 1 faces the top plate 4.

In the magnetic gap 5, a voice coil bobbin 7 with a voice coil 6 wound thereon is inserted. In other words, the voice coil 6 is inserted into the narrow magnetic gap 5 formed between the pole piece 1 and the top plate 4.

The voice coil bobbin 7 has a cylindrical body formed with an insulating material such as plastic having an insulating characteristic, a side wall of which is supported by a speaker frame 9 through a damper 8.

Further secured on the side wall of the voice coil bobbin 7 is one end of a cone type diaphragm 11, the other end of which is mounted onto an edge portion 10 extended from the speaker frame 9. A center cap 12 with a conical shape which is formed with a light and high heat conductive metallic material such as aluminum is mounted on a top portion of the voice coil bobbin 7.

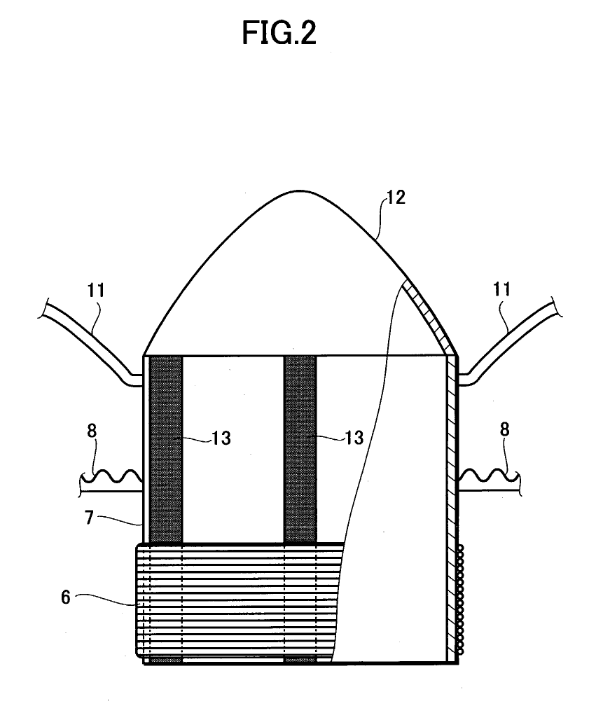

Referring to FIG. 2, the construction of the voice coil bobbin 7 will be described in detail. A plurality of heat conduction bodies 13 which are formed with a long metallic foil, respectively, is mounted like a strip of fancy paper on a side wall (outer wall) of the voice coil bobbin 7. One end of each heat conduction body 13 is connected to the center cap 12 made of metal, and the other end extends to a lower end portion of the voice coil bobbin 7.

The heat conduction body 13 is first pressed down on the voice coil bobbin 7, and then the voice coil 6 is wound around the outer wall of the voice coil bobbin 7 with the pressed heat conduction body 13, thereby allowing the voice coil 6, the plurality of heat conduction bodies 13, the center cap 12, and the voice coil bobbin 7 to be integrally formed.

Note that, in the present embodiment, the heat conduction body 13 is formed with a copper foil having a shape of a belt of predetermined width and length, so that the heat radiation effect can be improved as explained later. Moreover, not only the copper foil but also the other metallic foil such as aluminum, which is light in weight and superior in heat conductivity, namely has a high heat conductive rate, may be applied.

In addition, each heat conduction body 13 may be secured onto an outer wall of the voice coil bobbin 7 by an adhesive agent, or by winding the voice coil 6 onto the voice coil bobbin 7 with each heat conduction body 13 attached on the outer wall thereof without using the adhesive agent.

Further, the voice coil bobbin 7 may be formed by a material superior in heat-resistant characteristic such as plastic, and also the thin heat conduction body 13 may be directly formed on the outer wall of the voice coil bobbin 7 through an evaporation instead of the metallic foil.

In the loudspeaker apparatus having such a construction, when the current corresponding to a sound signal is supplied to the voice coil 6, a driving force is generated in the voice coil 6 by a magnetic flux of a magnetic gap 5 and the current flowing in the voice coil 6, thereby causing the voice coil bobbin 7 to make piston vibration in the direction of a central axis line according to variation of the sound signal.

Then, the piston vibration is transmitted to the cone type diaphragm 11 secured onto the voice coil bobbin 7, thereby causing the diaphragm 11 to vibrate so that the sound can be reproduced.

When the current is supplied to the voice coil 6, the generation of heat occurs. The generated heat is transmitted to a plurality of heat conduction bodies 13 pressed on the voice coil 6, and then to the center cap 12 through the heat conduction bodies 13. Thus, the generated heat is radiated from the center cap 12 which is superior in the heat conductive characteristic and has a large surface area, and also from the heat conduction bodies 13 themselves, so that the accumulation of the heat generated in the voice coil 6 and the voice coil bobbin 7 can be restrained.

Further, the voice coil bobbin 7 is formed with an insulating material in the present invention. Therefore, even if the piston vibration is made in the magnetic gap 5, an eddy current does not occur at the voice coil bobbin 7, so that the problem such as a magnetic damping can be prevented. In such a way, the sound with high sensitivity and superior frequency characteristic for the variation of the current supplied to the voice coil 6 can be reproduced.

Meanwhile, since the heat conduction body 13 is formed with the metallic foil, certainly the eddy current occurs at the heat conduction body 13 on a theory when the heat conduction body 13 makes the piston vibration in the magnetic gap 5. However, these heat conduction bodies 13 do not cover the whole of the side wall of the voice coil bobbin 7, but are attached thereon with a predetermined space held between each other. Therefore, the occurrence of the eddy current at the heat conduction body 13 may be ignored.

In this way, according to the present embodiment, the both of the improvement of heat radiation effect and the restraint of eddy current, which are both important problems for the moving coil type loudspeaker apparatus, can be simultaneously realized.

Note that each heat conduction body 13 is held between the voice coil bobbin 7 and the voice coil 6 in FIG. 2, but the present invention is not limited to such a construction.

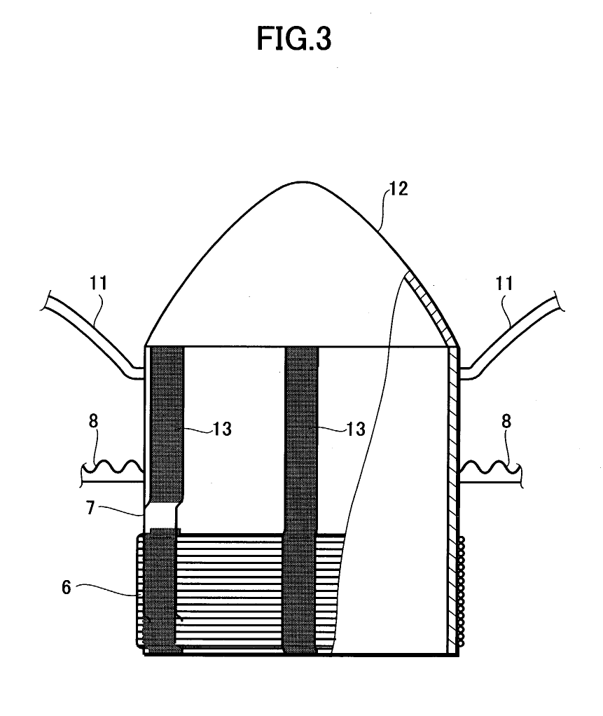

As shown in FIG. 3, as a modified example, each heat conduction body 13 may be attached by an adhesive agent onto an upper surface of the voice coil 6 so as to cover it after winding the voice coil 6 onto the voice coil bobbin 7.

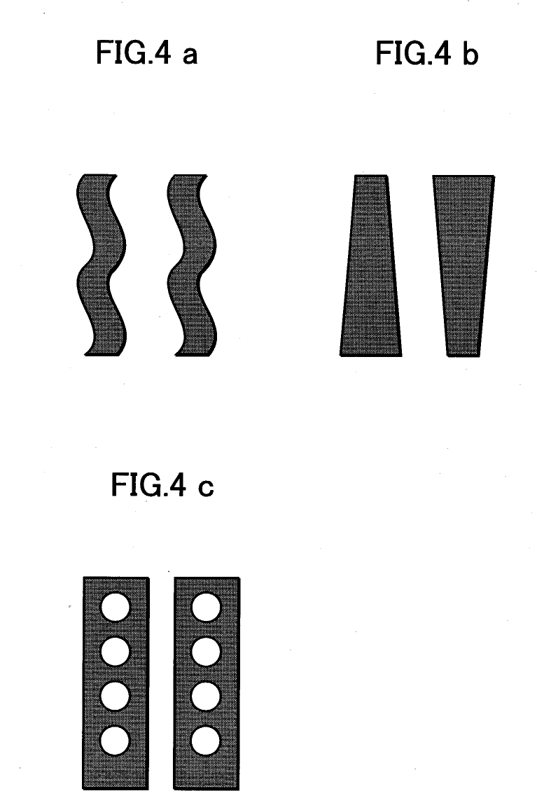

In FIGS. 2 and 3, each heat conduction body 13 has a shape of a rectangular band, but may be formed in a wavelike shape as shown in FIG. 4a, in a trapezoidal shape as FIG. 4b, or in a wide rectangular shape with holes partially formed therein as FIG. 4c.

Further, the present invention is not limited to the cases where each heat conduction body 13 is attached parallel to each other, or straightly from the center cap 11 to a lower end of the voice coil bobbin 7, but may be attached non-parallel to each other, or obliquely in the downward direction from the center cap 11.

In other words, the present invention includes all the constructions which satisfy the following condition, that is, the plurality of heat conduction bodies 13 are attached with a space between each other, and contacted to at least one side of the both voice coil bobbin 7 and voice coil 6, one end of each heat conduction body 13 being connected to the center cap 12.

It is desired that the width of the heat conduction body 13 is formed as narrowly as possible in order to restrain the occurrence of eddy current, while as widely as possible in order to improve the heat radiation effect. In order to simultaneously satisfy such contradictory conditions, the width of each heat conduction body 13 is formed as narrowly as possible in order to restrain the occurrence of eddy current, while the number of the narrow heat conduction body 13 is increased much in order to improve the heat radiation effect.

In such a way, the loudspeaker apparatus of the present invention has a superior effect of enabling the speaker components to be variously designed in order to restrain the occurrence of eddy current and improve the heat radiation effect.

In addition, as described above, the loudspeaker apparatus of the present invention has such a construction that the plurality of heat conduction bodies 13 are attached with a space between each other, and contacted to at least one side of the both voice coil bobbin 7 and voice coil 6, one end of each heat conduction body 13 being connected to the center cap 12. Accordingly, the present invention has superior effects that the heat generated at the voice coil can be efficiently radiated, and also the occurrence of eddy current can be restrained so much.

While the present invention has been described in connection with the preferred specific embodiments thereof, it will be understood that the description is intended to illustrate and does not limit the scope of the present invention, which is defined by the following claims.

What is claimed is:

1. A loudspeaker apparatus having a diaphragm, a bobbin connected to the diaphragm and provided with a coil, and a magnetic gap for assigning the coil a magnetic field, comprising:
a center cap provided on a top of the bobbin; and
a plurality of heat conduction bodies contacted with at least one of the bobbin and the coil, and connected to the center cap;
wherein the bobbin is formed with an insulating material, the center cap is formed with a metallic material superior in heat conductive characteristic, and the plurality of heat conduction bodies are formed with a metallic material superior in heat conductive characteristic having a shape of wide band, which are provided with a space held between each other, respectively.

2. The loudspeaker apparatus according to claim 1, wherein one end of the heat conduction body is connected to the center cap, and the other end is put between the bobbin and the coil.

3. The loudspeaker apparatus according to claim 1, wherein one end of the heat conduction body is connected to the center cap, and the other end is contacted with the coil wound around the bobbin.

4. The loudspeaker apparatus according to claim 1, wherein the metallic material forming the heat conduction body is a copper foil.
